(19) United States
(12) Patent Application Publication
(10) Pub. No.: US 2003/0043826 A1
(43) Pub. Date: Mar. 6, 2003

(54) Apparatus and method for client registration in an automatically switchable optical network

(76) Inventors: Joachim Charzinski, Oberschleissheim (DE); Bernd Stilling, Muenchen (DE); Uwe Pauluhn, Muenchen (DE)

Correspondence Address: Bell, Boyd & Lloyd LLC, P.O. Box 1135, Chicago, IL, 60690, US

(21) Appl. No.: 10/215,723

(22) Filed: Aug. 8, 2002

(30) Foreign Application Priority Data
Aug. 9, 2001 (DE) 101 39 157.9

(51) Int. Cl. H04L 12/28

(52) U.S. Cl. 370/405; 370/398

(57) ABSTRACT

The present invention relates to an optical communications method, a network node device and a transmission/reception device for use in an optical communications network, and also to an optical communications network having at least a first and a second transmission/reception device which are respectively connected to one of a number of network node devices in an optical transport network via which data can be interchanged between the first and the second transmission/reception device using optical signals, and having a central registration device for centrally storing data relating to the registration of the first and second transmission/reception devices within the optical communications network, wherein at least some of the registration data associated with a transmission/reception device are managed by that network node device to which the respective transmission/reception device is connected.

The present invention relates, generally, to an optical communications network, to a network node device and a transmission/reception device for use in such a communications network, and to an optical communications method.

Optical communications networks generally have a number of transmission/reception devices; e.g., a number of subscriber line or client devices which are respectively connected to a respective one of a number of network node devices via one or more optical fibers. The network node devices are connected to one another via a network having optical fibers, so that, when a number of interconnected network node devices are interposed, appropriate optical signals can be used to interchange data between the transmission/reception devices.

Data can be transmitted within the communications network using optical WDM binary signals; for example, (“WDM”=Wavelength Division Multiplex). In this case, a single optical fiber is used to transmit a number of pulsed optical signals which have been subjected to wavelength division multiplexing.

In the communications networks currently in operation, the data links respectively used within the network are not set up by the client devices themselves, but rather by a central control device or by a central network manager.

In contrast to this, in “ASON networks” (ASON=Automatically Switched Optical Network), the client device can independently set up connections to other client devices. To this end, a signaling channel is used to interchange appropriate (connection setup) signaling signals between the respective client device and a network node device connected to the latter. The actual useful data are transmitted using a separate useful data channel.

The optical network address of a particular client device in the address space of the optical communications network is not known to the other client devices. The client devices are therefore coupled via a further signaling channel to a central address management device storing the respectively valid network addresses for all the client devices. Before a data link is set up from the respective client device, the client device first uses appropriate signaling signals to request from the address management device the optical network address of that client device to which a data link is to be set up.

An object of the present invention is to provide a novel optical communications network, a novel network node device and a novel transmission/reception device for use in an optical communications network, and also a novel optical communications method.

### SUMMARY OF THE INVENTION

A basic concept of the present invention provides an optical communications network having at least a first and a second transmission/reception device which are respectively connected to one of a number of network node devices in an optical transport network via which data can be interchanged between the first and the second transmission/reception device using optical signals, and having a central registration device for centrally storing data relating to the registration of the first and second transmission/reception devices within the optical communications network, wherein at least some of the registration data associated with a transmission/reception device are managed by that network node device to which the respective transmission/reception device is connected.

Advantageously, only the respective optical network node devices can change the registration data stored in a registration database in the central registration device, but not the transmission/reception devices connected to the respective network node devices. The effect achieved by this is simpler management of the registration data as compared with the prior art. This is particularly advantageous when the transmission/reception devices connected to the network node devices belong to different administrative units.

Additional features and advantages of the present invention are described in, and will be apparent from, the following Detailed Description of the Invention and the Figures.

### BRIEF DESCRIPTION OF THE FIGURES

FIG. 1 shows a schematic illustration of an optical communications network based on the prior art.

FIG. 2 shows a schematic illustration of an automatically switched optical network (ASON).

FIG. 3 shows a schematic illustration of an optical communications network based on an exemplary embodiment of the present invention.

FIG. 4 shows a schematic illustration of the timing of signaling signals interchanged between a client device shown in FIG. 3, a network node device and a network address management device.

### DETAILED DESCRIPTION OF THE INVENTION

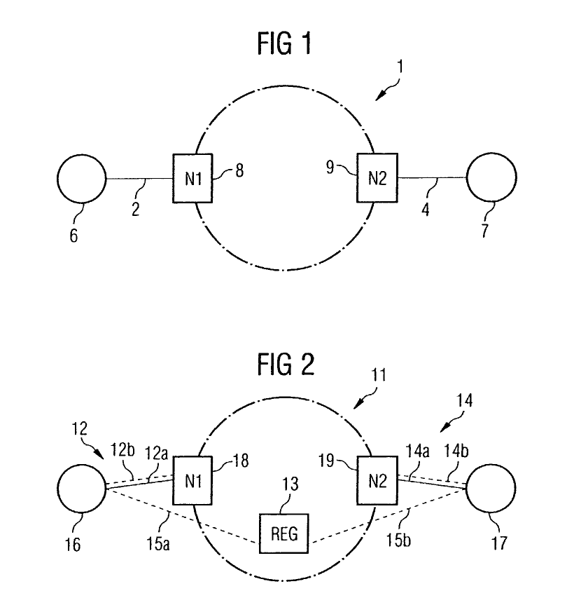

On the basis of FIG. 1, an optical communications network or optical transport network (OTN) 1 based on the prior art has a first and a second network node device 8, 9, a multiplicity of further network node devices (not shown in the present case), a first and a second client device 6, 7, and a multiplicity of further client devices (not shown in the present case).

The first client device 6 is connected to the first network node device 8 via an optical fiber 2. Correspondingly, the second client device 7 is connected to the second network node device 9 via an optical fiber 4. The network node devices 8, 9 (and the aforementioned further network node devices (not shown in the present case)) are connected to one another within the optical transport network (OTN) 1 via a multiplicity of optical fibers.

In the optical transport network (OTN) 1 shown in FIG. 1, the data links specifically used in each case for transmitting data between the individual network node devices are set up, without any influence of the client devices 6, 7, by a central network management system or a central control device.

FIG. 2 shows an automatically switched optical network or ASON network 11 which has a multiplicity of network node devices 18, 19 connected to one another via appropriate optical fibers.

In addition, the ASON network 11 has a number of client devices 16, 17 which are connected to an appropriate network node device 18, 19 via a respective (or a number of, e.g., two) optical fiber 12, 14. In this case, a respective first optical fiber channel 12a, 14a is used for transmitting useful signals, and a second optical fiber channel 12b, 14b is used for transmitting signaling signals; for example, used for switching the useful signals. In the ASON network 11 shown in FIG. 2, the respective client device 16 can independently set up a data link to another client device 17 by emitting appropriate (connection setup) signaling signals via the signaling channel 12b, 14b.

The optical network address of a particular client device 17 in the address space of the ASON network 11 is not known to the other client devices 16. The first and second client devices 16, 17 are therefore respectively coupled, via a further signaling channel 15a, 15b, directly to a central network address management device 13 storing the respectively valid network addresses for all the client devices 16, 17.

Before a data link is set up, the respective client device 16 first uses appropriate signaling signals transmitted via the further signaling channel 15a to request from the network address management device 13 the optical network address of that client device 17 to which a data link is to be set up.

To set up the data link, the respective client device 16 then uses the signaling channel 12b to send a connection setup signaling signal containing, inter alia, the aforementioned optical network address of the target client device 17 to the corresponding network node device 18, from where the data link is then progressively relayed to further network node devices, and finally to the target client device 17.

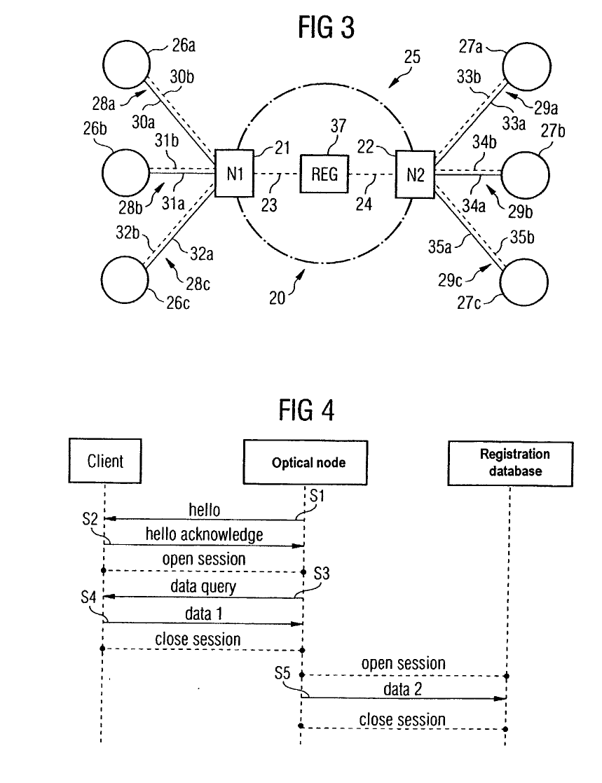

FIG. 3 shows an optical communications network 20 (in this case: an automatically switched optical network or ASON network) based on an exemplary embodiment of the present invention. This network has a multiplicity of network node devices 21, 22 connected to one another via an optical fiber network 25 (shown by a dash-dot ellipse in the illustration in FIG. 3), and a multiplicity of subscriber line or client devices 26a, 26b, 26c, 27a, 27b, 27c. These each can be, by way of example, SDH, ATM or IP client devices connected to further, client-side networks; e.g., can be IP routers (SDH=Synchronous Digital Hierarchy, ATM=Asynchronous Transfer Mode, IP=Internet Protocol).

Within the optical fiber network 25, every network node device 21, 22 is connected via, respectively, one or more optical fiber bundles or via one or more single optical fibers to, respectively, one or more (e.g.; two, three or four) further network node devices 21, 22.

For data transmission within the optical fiber network 25 or the optical communications network 20, it is possible to use, by way of example, a WDM data transmission method (WDM=Wavelength Division Multiplex). On the basis of wavelength division multiplex, respectively different wavelength ranges can be used for simultaneously transmitting a number of different, pulsed optical binary signals via each optical fiber provided in the network (the binary signals respectively being used, by way of example, for data transmission between respectively different client devices 26a, 26b, 26c, 27a, 27b, 27c).

As FIG. 3 also shows, a first, a second and a third client device 26a, 26b, 26c are connected to a first network node device 21 (more precisely: to respectively different ports of the network node device 21) via corresponding client interface devices via a respective (or a respective number of) optical fiber 28a, 28b, 28c. Correspondingly, a fourth, a fifth and a sixth client device 27a, 27b, 27c are connected to various ports of the second network node device 22 via corresponding client interface devices via a respective (or a respective number of) optical fiber 29a, 29b, 29c.

Between the client devices 26a, 26b, 26c and the network node device 21 connected thereto, and between the client devices 27a, 27b, 27c and the network node device 22 connected thereto, a respective first optical fiber channel 30a, 31a, 32a, 33a, 34a, 35a is used for transmitting useful signals (shown by solid lines in the illustration in FIG. 3), and a respective second optical fiber channel 30b, 31b, 32b, 33b, 34b, 35b is used for transmitting signaling signals (shown by dashed lines in the illustration in FIG. 3), which are explained in more detail below.

The various optical fiber channels 30a, 31a, 32a, 33a, 34a, 35a and 30b, 31b, 32b, 33b, 34b, 35b, respectively running in parallel, each can be connected via a number of (e.g., two or three) different optical fibers or, by way of example, via one and the same optical fiber (e.g., using wavelength division multiplex or time division multiplex).

The optical communications network 20 also has a central network address management device 37; e.g., a server computer for a network address directory service (REG or registry), which is connected to corresponding network node devices 21, 22 via respective optical fiber channels 23, 24 routed via appropriate further optical fibers.

As already mentioned above, the client devices 26a, 26b, 26c, 27a, 27b, 27c are connected to the network node devices 21, 22 via an appropriate client interface device (e.g., a UNI (User Network Interface) interface device) and the aforementioned optical fibers 28a, 28b, 28c, 29a, 29b, 29c, further interface devices (for example, for connecting the client devices 26a, 26b, 26c, 27a, 27b, 27c to the network address management device 37) are not provided.

In order to check whether a client device 26a is connected at a particular port on a network node device 21, the respective network node device 21 uses appropriate optical binary pulses to emit a first signaling signal S1 (“hello”) via the appropriate optical fiber channel 30b, as shown in FIG. 4.

If a client device 26a is currently connected at the appropriate port on the network node device 21, this is indicated to the network node device 21 by virtue of the corresponding client device 26a sending a further signaling signal S2 (“hello acknowledge”) to the network node device 21 via the optical fiber channel 30b in response to the connection query signaling signal S1.

If the network node device 21 does not receive a response to the connection query signaling signal S1 within a predetermined period of time (e.g., because there is no client device connected at the respective port), the network node device 21 prompts a connection query signaling signal S1 to be resent via the appropriate optical fiber channel 30b, etc.

As soon as the network node device 21 receives a client connection signaling signal S2 (“hello acknowledge”) from a client device 26a connected at the respective port, the network node device 21 sets up a data communications link to the respective client device 26a (“open session”).

To request client registration information, the network node device 21 then uses appropriate optical binary pulses to send a further signaling signal S3 (“data query”) to the client device 26a via the optical fiber channel 30b.

The registration data query signaling signal S3 can contain information about which client registration data are to be transmitted from the client device 26a to the network node device 21 (e.g., data regarding client type (SDH, ATM, IP client, etc.), and/or client interface type and/or (access) authorizations for the client device and/or regarding a client identifier, and/or a wavelength used by the client device, and/or a client network address, and/or properties assigned to the network node device 21 in the client's network (e.g., their IP address) etc.). The wavelength used by the client device can, by way of example, be requested if the client device is not connected to the network node device 21 via a transponder ensuring the respectively desired wavelength.

The respective client registration data are read from a memory device (not shown in FIG. 3) in the client device 26a and are forwarded to the network node device 21 using a signaling signal S4 (“data1”) transmitted via the optical fiber channel 30b.

The network node device 21 then clears down the existing data communications link to the client device 26a again (“close session”).

In one alternative exemplary embodiment (not shown in the present case), the data interchanged between the client device 26a and the network node device 21 (and vice versa) are encrypted for security reasons. In addition, data interchange can alternatively or additionally take place between client device and network node device 26a, 21 only after the client device 26a has authenticated itself with the network node device 21. Alternatively, the network node device 21 additionally can be authenticated with the client device 26a, conversely.

In another alternative exemplary embodiment, one or more of the client devices 26a, 26b, 26c, 27a, 27b, 27c have no UNI interface (UNI=User Network Interface). In that case, the aforementioned registration data are not transmitted, as described above, from the client device 26a, 26b, 26c, 27a, 27b, 27c to the respective network node device 21, 22 using the aforementioned dialog between the corresponding client device 26a, 26b, 26c, 27a, 27b, 27c and the respective network node device 21, 22 (“hello”, “hello acknowledge”, “data query”, “data1” signals). Instead, the respective registration data are transmitted, centrally for a number or all of the client devices 26a, 26b, 26c, 27a, 27b, 27c, from a network control device or a central network management system to the respective network node device 21, 22 via a number of separate optical fiber channels. Alternatively, the respective registration data also can be entered into the appropriate network node device 21, 22 manually, for example.

In the network node device 21, the registration data (e.g., transmitted using the registration data signaling signal S4, or sent by the central network management system, or entered manually) are complemented by further client registration data. These data may, by way of example, have been previously stored in a memory device (not shown in FIG. 3) in the network node device 21, or can be ascertained only after reception of the registration data signaling signal S4 by a control device (not shown) in the network node device 21 (e.g., the port number to which the client device 26a is connected).

By way of example, it is conceivable for the network node device 21 to infer from the aforementioned registration data transmitted by the client device 26a which client registration data are (freely) configurable and which are not. It is possible, by way of example, that the respective address of the client device 26a has not been stipulated beforehand, but rather can be allocated by the network node control device.

As soon as the network node device 21 contains all the registration data required, the network node device 21 sets up a data communications link to the network address management device 37 (“open session”), as shown in FIG. 4.

The network node device 21 then uses appropriate optical binary pulses to send a signaling signal S5 (“data2”) to the network address management device 37 via the optical fiber channel 23. This signaling signal contains not only the registration data transmitted to the network node device 21 by the client device 26a (for example, using the signal S4), but also the further client registration data complemented by the network node device 21 (e.g., information regarding client type, and/or client interface type, and/or access authorizations, and/or client network address, and/or the network address of the network node device, etc.).

In one alternative exemplary embodiment (not shown in the present case), the data interchanged between the network node device 21 and the network address management device 37 (and vice versa) are encrypted for security reasons. In addition, data interchange between the network address device and the network node device 37, 21 can alternatively or additionally take place only after the network node device 21 has authenticated itself with the network address management device 37. Alternatively, the network address management device 37 additionally can be authenticated with the network node device 21, conversely.

The aforementioned registration data are stored in a memory device (not shown) in the network address management device 37 in association with the respective client device or with a corresponding client identifier.

To set up a data link from, by way of example, the client device 27a to the client device 26a, appropriate optical binary pulses transmitted via the optical fiber channel 33b are first used to send a (connection setup query) signaling signal to the second network node device, the signal containing, inter alia, the aforementioned identifier identifying the target client device 26a (the optical network address of the target client device 26a is not known to the client device 27a).

Next, the optical fiber channel 24 is used to send a (database interrogation) signaling signal containing, by way of example, the aforementioned identifier for the target client device 26a and, by way of example, an identifier for the querying client device 27a to the network address management device 37 from the network node device 22. The (database interrogation) signaling signal can contain information about which client registration data are to be transmitted from the network address management device 37 to the network node device 22.

The respective client registration data (e.g., the optical network address of the target client device 26a, or, by way of example, information regarding the (access) authorizations of the querying client device 27a) are read from the memory device in the network address management device 37 and are forwarded to the network node device 22 using a signaling signal transmitted via the optical fiber channel 24.

If the querying client device 27a is authorized to access the optical fiber network 25, the network node device 22 (or a network control device (not shown)) selects one of the further network node devices connected to the network node device 22 as that network node device which is to be used to relay the connection which is to be set up. Next, the network node control device prompts a (connection setup query) signaling signal containing, inter alia, the optical network address of the target client device 26a to be sent to the selected further network node device from the network node device 22. The further network node device sends a further signal, corresponding to the connection setup query signaling signal, to a further network node device, etc.

In this way, a data link routed via the path including client device 27a, network node device 22, . . . , network node device 21, client device 26a is progressively set up between the two client devices 26a, 27a.

The exemplary embodiments described achieve, inter alia, simplification of the client registration data management as compared with the prior art. The reason for this is that every network node device 21, 22 manages the respective registration data for the client devices connected to it.

Although the present invention has been described with reference to specific embodiments, those of skill in the art will recognize that changes may be made thereto without departing from the spirit and scope of the present invention as set forth in the hereafter appended claims.

1. An optical communications network, comprising:
at least first and second transmission/reception devices which are respectively connected to one of a plurality of network node devices in an optical transport network via which data can be interchanged between the first and second transmission/reception devices using optical signals; and
a central registration device for centrally storing registration data relating to registration of the first and second transmission/reception devices within the optical communications network;
wherein at least some of the registration data associated with one of the transmission/reception devices is managed by one of the network node devices to which the respective transmission/reception device is connected.

2. An optical communications network as claimed in claim 1, wherein the respective transmission/reception device is connected to the corresponding network node device via a data channel, and at least some of the registration data is transmitted from the respective transmission/reception device to the corresponding network node device via the data channel.

3. An optical communications network as claimed in claim 1, wherein the respective transmission/reception device is connected to the corresponding network node device via a further data channel via which actual useful data is transmitted from the respective transmission/reception device to the corresponding network node device.

4. An optical communications network as claimed in claim 1, wherein at least some of the registration data associated with one of the transmission/reception devices is generated by the network node device associated with the respective transmission/reception device.

5. An optical communications network as claimed in claim 1, wherein at least some of the registration data associated with one of the transmission/reception devices is transmitted from a central network control device to the corresponding network node device via an additional data channel.

6. An optical communications network as claimed in claim 1, wherein at least some of the registration data associated with one of the transmission/reception devices is transmitted from the respective network node device to the central registration device via a data channel.

7. An optical communications network as claimed in claim 1, wherein at least some of the registration data associated with one of the transmission/reception devices can be changed only by the network node device to which the respective transmission/reception device is connected.

8. An optical communications network as claimed in claim 1, wherein at least some of the registration data associated with the first transmission/reception device can be read from the central registration device via a data channel by the network node device which is respectively associated with the second transmission/reception device.

9. An optical communications network as claimed in claim 1, wherein no direct data link is provided between the respective transmission/reception device and the central registration device.

10. An optical communications network as claimed in claim 1, wherein the registration data contains information regarding an optical network address associated with the respective transmission/reception device in an address space of the optical transport network.

11. An optical communications network as claimed in claim 1, wherein the registration data contains information regarding data access authorization of the respective transmission/reception device to data stored within the optical communications network.

12. An optical communications network as claimed in claim 1, wherein the registration data contains information regarding properties of optical signals emitted by the respective transmission/reception device, including information regarding a wavelength of the optical signals.

13. An optical communications network as claimed in claim 1, wherein the registration data contains information regarding properties of at least one of the respective transmission/reception device and an interface used thereby, including related type information.

14. An optical communications network as claimed in claim 1, wherein the registration data contains information regarding properties assigned to the respective network node device in a further network, which is connected to the transmission/reception device associated with the respective network node device.

15. An optical communications network as claimed in claim 1, wherein at least one of the first transmission/reception device and the second transmission/reception device is a subscriber line device.

16. An optical communications network as claimed in claim 1, wherein at least one of the first transmission/reception device and the second transmission/reception device is a client device.

17. An optical communications network as claimed in claim 1, wherein the data is transmitted using optical signals which have been subject to wavelength division multiplexing.

18. A network node device in an optical transport network via which data can be interchanged between first and second transmission/reception devices of an optical communications network using optical signals, the first and second transmission/reception devices being respectively connected to one of a plurality of the network node devices, with the optical communications network further including a central registration device for centrally storing registration data relating to registration of the first and second transmission/reception devices within the optical communications network, the network node device comprising parts for managing at least some of the registration data associated with one of the transmission/reception devices to which the network node device is connected.

19. A transmission/reception device in an optical communications network which includes a plurality of the transmission/reception devices respectively connected to a plurality of network node devices in an optical transport network, the transmission/reception device comprising parts for effecting data interchange between the transmission/reception device and another transmission/reception device using optical signals, with the optical communications network including a central registration device for centrally storing registration data relating to registration of the plurality of transmission/reception devices within the optical communications network, and wherein at least some of the registration data associated with the transmission/reception device is managed by the network node device to which the transmission/reception device is connected.

20. An optical communications method in an optical communications network, the method comprising the steps of:
providing at least first and second transmission/reception devices which are respectively connected to one of a plurality of network node devices in an optical transport network via which data can be interchanged between the first and second transmission/reception devices using optical signals;
centrally storing registration data, via a central registration device, relating to registration of the first and second transmission/reception devices within the optical communications network; and
managing at least some of the registration data associated with one of the transmission/reception devices by one of the network node devices to which the respective transmission/reception device is connected.
